(19) United States
(12) Patent Application Publication
(10) Pub. No.: US 2014/0310034 A1
(43) Pub. Date: Oct. 16, 2014

(54) PERFORMANCE INDICATOR ANALYTICAL FRAMEWORK

(71) Applicant: SAP AG, Walldorf (DE)

(72) Inventors: Haishu LI, Shanghai (CN); Jinghui LI, Shanghai (CN); Zhongbo LI, Shanghai (CN); Jin XU, Shanghai (CN); Xing ZHANG, Shanghai (CN); Jie ZHAO, Shanghai (CN); Haozhu WANG, Shanghai (CN); Xiangyun ZHONG, Shanghai (CN)

(73) Assignee: SAP AG, Walldorf (DE)

(21) Appl. No.: 13/866,045

(22) Filed: Apr. 19, 2013

(30) Foreign Application Priority Data
Apr. 12, 2013 (CN) 201310127359.0

(51) Int. Cl. G06Q 10/06

(52) U.S. Cl. CPC G06Q 10/06393
USPC 705/7.11

(57) ABSTRACT

Described herein is a technology for facilitating analysis of performance indicators. In accordance with one aspect, a hierarchical structure with a node representing a performance indicator is configured. Such configuration may include mapping one or more lowest level nodes to one or more data models for retrieving transactional data. In addition, one or more internal nodes of the hierarchical structure may be configured, including mapping the one or more internal nodes to one or more corresponding child nodes. The configuration data generated by such configuration may then be stored in a database for subsequent retrieval to generate a report.

### TECHNICAL FIELD

The present disclosure relates generally to an analytical framework for performance indicators.

### BACKGROUND

In a fast changing and highly competitive economic environment, performance indicators or key performance indicators (KPIs) are widely used by business decision makers to measure the profitability and sustainability of their organizations. Generally, KPIs are business metrics that are used to present the status and trends in an organization. KPIs can be grouped into 3 categories: (1) cross industry KPIs (e.g., profit margin, revenue, etc.); (2) industry-specific KPIs (e.g., vehicle utilization rate in the transportation industry); and (3) enterprise-specific KPIs that are defined and used by individual business organizations.

While there may be thousands of KPIs used in different scenarios, each type of stakeholder is only interested in a few specific KPIs. For instance, investors may be concerned with the return of equity, while sales managers typically focus on sales revenue and sales expense. Existing solutions, however, do not effectively present the relevant KPIs to the stakeholders. KPIs and related data are typically not organized in a meaningful and readable form, making it difficult for the user to perform a root-cause analysis.

Further, KPI computation is typically based on a huge amount of transactional data retrieved from online transaction processing (OLTP) systems. OLTP systems are used to carry out the day-to-day business functions, such as enterprise resource planning (ERP), customer relationship management (CRM), and so forth. OLTP systems are optimized for processing very small amounts of detailed data, but are generally not suited for analytical tasks that involve ad-hoc analysis of large data amounts.

To compute the KPIs, existing solutions are typically implemented on an online analytical processing (OLAP) system (e.g., SAP BW) that is optimized for complex analytical and ad-hoc queries with a rapid execution time. OLAP systems typically retrieve data from the OLTP system using extraction, transformation and loading (ETL) tools asynchronously. Such data preparation is time-consuming, and real-time KPI computation is not possible. Moreover, the cost of implementing such solutions is high, since the user has to write complex logic for each KPI using a high level language (e.g., ABAP) to read raw data from the OLTP system and calculate KPI values from the raw data.

Therefore, there is a need for an improved analytical framework that addresses the above-mentioned challenges.

### SUMMARY

A computer-implemented technology for facilitating analysis of performance indicators is described herein. In accordance with one aspect, a hierarchical structure with a node representing a performance indicator is configured. Such configuration may include mapping one or more lowest level nodes to one or more data models for retrieving transactional data. In addition, one or more internal nodes of the hierarchical structure may be configured, including mapping the one or more internal nodes to one or more corresponding child nodes. The configuration data generated by such configuration may then be stored in a database.

In accordance with another aspect, configuration data of a hierarchical structure is received. A node of the hierarchical structure represents a performance indicator. Transactional data may also be retrieved via a data model specified by the configuration data. Based on the configuration data, one or more lowest level nodes are populated based on the transactional data, and one or more internal nodes may be populated based on one or more corresponding child nodes. A report of the populated hierarchical structure may then be presented.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures, in which like reference numerals designate like parts, and wherein:

FIG. 1 is a block diagram illustrating an exemplary system;

FIG. 2 shows an exemplary architecture;

FIG. 3 shows an exemplary method of generating a performance indicator tree;

FIG. 4a shows an exemplary mapping table that stores the associations between data model attributes and node dimensions;

FIG. 4b shows another exemplary mapping table that stores the associations between data model measures and node key figures;

FIG. 5a shows an exemplary mapping table that stores the associations between parent node dimensions and the child node dimensions;

FIG. 5b shows another exemplary mapping table that stores the relationship between parent nodes and child nodes;

FIG. 6 shows an exemplary report for the node “Revenue”;

FIG. 7 shows a method of generating a performance indicator report during runtime based on the configuration data;

FIG. 8 shows an exemplary report displaying a performance indicator tree; and

FIG. 9 shows a more detailed view of the selected node.

### DETAILED DESCRIPTION

In the following description, for purposes of explanation, specific numbers, materials and configurations are set forth in order to provide a thorough understanding of the present frameworks and methods and in order to meet statutory written description, enablement, and best-mode requirements. However, it will be apparent to one skilled in the art that the present frameworks and methods may be practiced without the specific exemplary details. In other instances, well-known features are omitted or simplified to clarify the description of the exemplary implementations of the present framework and methods, and to thereby better explain the present framework and methods. Furthermore, for ease of understanding, certain method steps are delineated as separate steps; however, these separately delineated steps should not be construed as necessarily order dependent in their performance.

A performance indicator analytical framework is described herein. One aspect of the present framework flexibly models performance indicators using a hierarchical structure (e.g., tree). Performance indicators may provide means for measuring the performance of an entity or an organizational unit within the entity. Performance indicators may relate to, for example, marketing, manufacturing, information technology, supply chain management, and so forth.

In accordance with some implementations, the hierarchical structure is a performance indicator tree structure. It should be appreciated that any other types of hierarchical structures may also be used. Each node of the hierarchical structure may represent a single performance indicator with one or more dimensions. Key figure values of internal nodes may be derived from key figure values of child nodes. Leaf nodes are mapped to a pre-selected data model to retrieve transactional data from a database. The configuration of the hierarchical structure is highly customizable, and the user can define personalized settings without having to write complex code to implement the calculation logic of each node.

In some implementations, an interactive report view of the hierarchical structure is dynamically generated. The user may easily navigate from one performance indicator to its deterministic lower level performance indicators to trace the root cause of, for instance, a performance issue. For example, profit margin is determined by profit divided by revenue. The user may investigate whether a low profit margin is caused by lower profit, high revenue, or both, by navigating the report view of the hierarchical structure.

Another aspect of the present framework facilitates multi-dimensional analysis of performance indicators. Attributes inherited from the underlying data model may be mapped to the dimensions of the performance indicators. Dimensions, as used herein, generally refer to categories of a data item. A user may perform a multi-dimensional analysis by navigating the hierarchical structure and selecting the dimensions of interest. For example, a general sales manager of the company may pay the most attention to the total sales revenue, while the regional sales managers are primarily interested in their respective regional sales revenue. The performance indicator “sales revenue” may be “drilled-down” by the dimension “region” to provide a more detailed and useful information to each regional sales manager.

Yet another aspect of the present framework leverages an in-memory database that combines OLTP and OLAP systems to improve performance. Transactional data models may be consumed without the need for preprocessing and aggregation. Data may be replicated from the OLTP system in near real-time. Further, in-memory computing may be fully leveraged to perform real-time computation of performance indicators directly based on the transactional data. These and other advantages and exemplary aspects will be described in more detail in the following description.

For purposes of illustration, the DuPont Financial Analysis Method is used to model the performance indicators. The DuPont method is an expression that divides the return of investment (ROI) performance indicator into two performance indicators, as follows:

ROI=(Profit margin)*(Asset turnover) (1)

“Profit margin” and “asset turnover” can further be determined by other performance indicators, as follows:

Profit margin=(EBIT)/(Assets) (2)

Asset Turnover=(Operating Income)/(Assets) (3)

where EBIT refers to Earnings before Interest and Tax. It should be appreciated that other types of indicators and other methods of calculating the indicators may also be used.

In addition, the framework described herein may be implemented as a method, computer-controlled apparatus, a computer process, a computing system, or as an article of manufacture such as a computer-usable medium. These and various other features will be apparent from the following description.

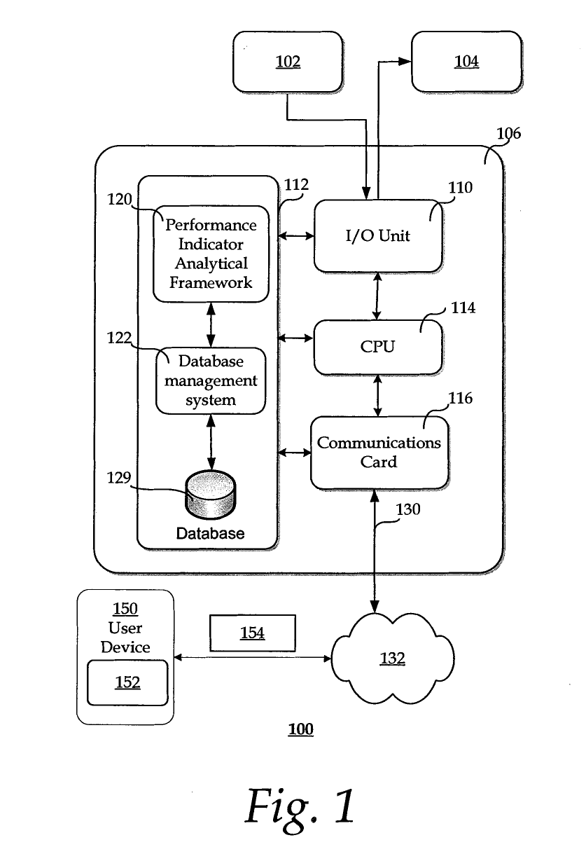

FIG. 1 shows a block diagram illustrating an exemplary system 100 that may be used to implement the framework described herein. System 100 may include a computer system 106 communicatively coupled to an input device 102 (e.g., keyboard, touchpad, microphone, camera, etc.) and an output device 104 (e.g., display device, monitor, printer, speaker, etc.). Computer system 106 also may include a communications card or device 116 (e.g., a modem and/or a network adapter) for exchanging data with network 132 using a communications link 130 (e.g., a telephone line, a wireless network link, a wired network link, or a cable network). Network 132 may be a local area network (LAN) or a wide area network (WAN). The computer system 106 may be communicatively coupled to one or more other computer systems 154 via network 132. For example, computer system 106 may act as a server and operate in a networked environment using logical connections to one or more user devices 150. User devices 150 may include components similar to the computer system 106, and may be in the form of a desktop computer, mobile device, tablet computer, communication device, etc.

Computer system 106 includes a central processing unit (CPU) 114, an input/output (I/O) unit 110, and a memory module 112. Other support circuits, such as a cache, power supply, clock circuits and a communications bus, may also be included in computer system 106. In addition, any of the foregoing may be supplemented by, or incorporated in, application-specific integrated circuits. Examples of computer system 106 include a handheld device, a mobile device, a personal digital assistance (PDA), a workstation, a server, a portable laptop computer, another portable device, a mini-computer, a mainframe computer, a storage system, a dedicated digital appliance, a device, a component, other equipment, or some combination of these capable of responding to and executing instructions in a defined manner.

Memory module 112 may be any form of non-transitory computer-readable media, including, but not limited to, dynamic random access memory (DRAM), static random access memory (SRAM), Erasable Programmable Read-Only Memory (EPROM), Electrically Erasable Programmable Read-Only Memory (EEPROM), flash memory devices, magnetic disks, internal hard disks, removable disks, magneto-optical disks, Compact Disc Read-Only Memory (CD-ROM), any other volatile or non-volatile memory, or a combination thereof.

Memory module 112 serves to store machine-executable instructions, data, and various software components for implementing the techniques described herein, all of which may be processed by CPU 114. As such, the computer system 106 is a general-purpose computer system that becomes a specific purpose computer system when executing the machine-executable instructions. Alternatively, the various techniques described herein may be implemented as part of a software product, which is executed via a performance indicator analytical framework 120. Each computer program may be implemented in a high-level procedural programming language (e.g., C, C++, Java, Advanced Business Application Programming (ABAP™) from SAP® AG, etc.), or in assembly or machine language if desired. The language may be a compiled or interpreted language. The machine-executable instructions are not intended to be limited to any particular programming language and implementation thereof. It will be appreciated that a variety of programming languages and coding thereof may be used to implement the teachings of the disclosure contained herein.

In one implementation, the memory module 112 of the computer system 106 includes a performance indicator analytical framework 120, a database management system (DBMS) 122 and a database 129. The performance indicator analytical framework 120 may store source code and executable machine code for performing the techniques described herein. More particularly, the performance indicator analytical framework 120 may facilitate the configuration and dynamic generation of the hierarchical structure used to model performance indicators. More details of these exemplary features will be provided in the following description.

The performance indicator analytical framework 120 is communicatively coupled to the DBMS 122. In some implementations, the performance indicator analytical framework 120 connects to the DBMS 122 to fetch data via database communication protocols, such as Java Database Connectivity (JDBC). Other types of connections are also useful. The DBMS 122 is a set of programs that enables storing, modifying and extracting data from a database 129. A user at the user device 150 may interact with a user interface 152 to communicate with the database 129 via the performance indicator analytical framework 120 and the DBMS 122.

In one implementation, database 129 is an in-memory database that relies primarily on the system's main memory for efficient computer data storage. More particularly, data in an in-memory database resides in volatile memory and is not persistently stored on a hard drive, thereby allowing the data to be instantly accessed and scanned at a speed of several megabytes per millisecond. The in-memory database 129 allows seamless access to, and propagation of, high volumes of data in real-time. Parallel processing may further be achieved by using a multicore processor 114 in conjunction with the in-memory database 129. In-memory database technology includes systems such as SAP's HANA (high performance analytic appliance) in-memory computing engine.

Column-based data storage may be implemented in the in-memory database 129, where data tables are stored as columns of data, in sequence and in compressed memory blocks. This may facilitate faster aggregation of data when calculations are performed on single columns. Alternatively, row-based data storage is also possible. In some implementations, instead of updating entire rows, only fields that have changed will be updated. This avoids having to lock entire data tables during updates to prevent conflicting modifications to a set of data. High levels of parallelization may be achieved, which is critical to real-time processing of live data streams and performing constant and substantially simultaneous updates.

It should be appreciated that the different components of the computer system 106 may be located on different machines. For example, the performance indicator analytical framework 120, DBMS 122 and database 129 may be implemented on different physical machines or computer systems. It should further be appreciated that the different components of the user device 150 may also be located on the computer system 106.

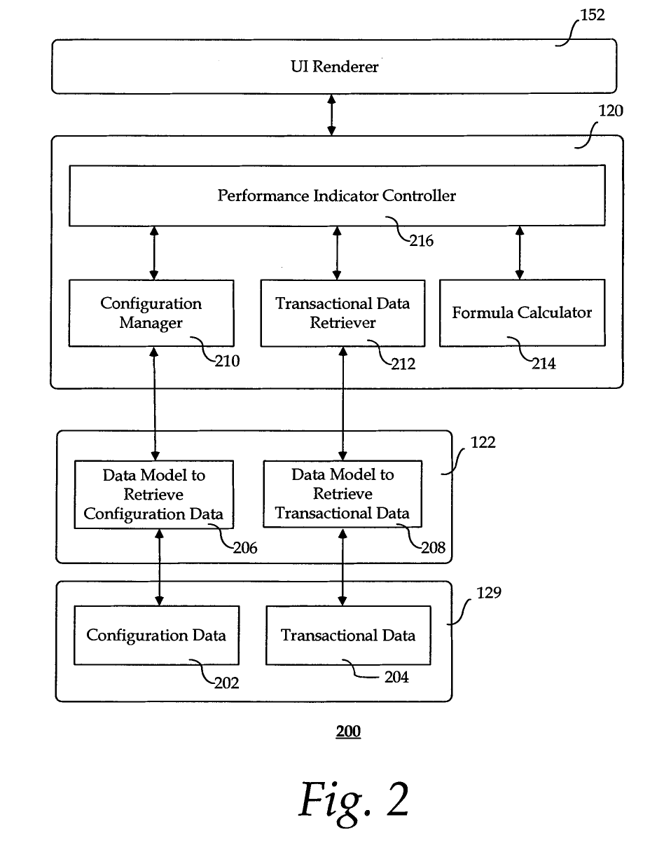

FIG. 2 shows an exemplary architecture 200 of various components of the system 100. It should be noted that in the following discussion, reference will be made, using like numerals, to the features described in FIG. 1.

In some implementations, database 129 may store configuration data 202 and transactional data 204, among other components that are not shown for clarity. Configuration data 202 serves to customize or personalize the performance indicator analytical framework 120. For instance, the configuration data 202 includes pre-defined properties of nodes in the hierarchical structure, including dimension mappings and key figure definitions, as will be described in more details in the following description. Configuration data 202 may be generated in response to settings received from a user via a user interface. Alternatively, configuration data 202 may be derived from content delivered by a content distribution network or content provider (e.g., SAP®). Such configuration data 202 may then be stored and retrieved from the database 129 via the data model 206.

Transactional data 204 may provide a source of data used to generate information for calculating the values of the performance indicators (or key figures). Transactional data 204 can relate to, or be generated in the operation of, an organization such as an enterprise that sells products or services. Examples of transactional data 204 include database information, updates or changes, messages, actions, or combinations thereof.

Both configuration data 202 and transactional data 204 may be retrieved via a service interface provided by data models 206 and 208 respectively. Data models 206 and 208 define the structure of the data retrieved from the database 129. For instance, the HANA database from SAP® AG includes data models that organize data as tables or views. Any other types of data models may also be used. Tables are tabular data structures, each row identifying a particular entity and each column having a unique name. Views are combinations and selections of data from tables modeled to serve a particular purpose. Examples of views available in the HANA database include analytic views used for calculation and aggregation “based on star schema” or the like, attribute views used for all type of joins, and calculation views that perform complex calculations that cannot be achieved by the attribute or analytic views alone. Each data model may include one or more attributes and measures associated with the data structure. An “attribute” may refer to a table column or a particular data field of a table row. A “measure” is an attribute for which a calculation may be defined. DBMS 122 may manage and store a set of pre-defined data models for retrieving configuration data 202 and transactional data 204 from the database 129. The set of data models may be pre-defined by a content provider (e.g., SAP) or an end-user.

In some implementations, the performance indicator analytical framework 120 includes a performance indicator controller 216, a configuration manager 210, a transactional data retriever 212 and a formula calculator 214. The operations of these components may be customized or controlled by the configuration data 202.

Configuration manager 210 may serve to manage the input, storage and retrieval of configuration data 202. Transactional data retriever 212 may serve to dynamically retrieve transactional data 204 from the database 129 during runtime. Formula calculator 214 may serve to compute the values of the performance indicators (or key figures) modeled in the hierarchical structure based at least in part on the retrieved transactional data 204. For instance, formula calculator 214 may apply operators on the raw transactional data 204 and the intermediate data generated during recursive calculation of key figures, as will be explained in more detail later. The operators may include, for example, add, subtract, average, maximum, minimum, and so forth. Such operators may be pre-defined and selected by the configuration data to determine how the formula calculator 214 computes the performance indicators (or key figures). The performance indicator controller 216 may serve to coordinate the operations of the configuration manager 210, transactional data retriever 212 and the formula calculator 214.

The user-interface (UI) renderer 152 receives the hierarchical structure from the performance indicator analytical framework 120, and dynamically generates the front-end representation code (e.g., HTML5) so that a report may be presented and accessed from the user device 150. In some implementations, the UI renderer 152 can assist the system 100 with presenting the report in a format specified by a system or user. Examples of optional user interface components may include windows, menus, buttons, check boxes, charts, hierarchical structure representation and icons.

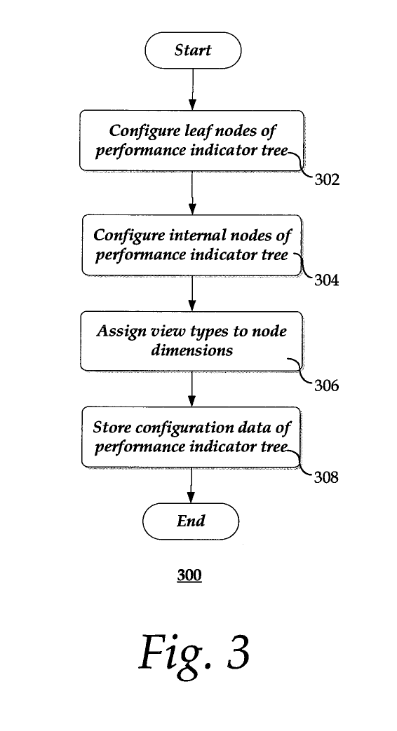

FIG. 3 shows an exemplary method of generating a performance indicator tree for modeling performance indicators. The method 300 may be implemented by the system 100 as previously described with reference to FIG. 1, or architecture 200 as previously described with reference to FIG. 2. It should be noted that in the following discussion, reference will be made, using like numerals, to the features described in FIGS. 1 and 2. It should also be appreciated that although FIG. 3 is described in the context of a performance indicator tree, any other type of hierarchical structure with multiple levels may also be used to model the performance indicators.

At 302, one or more leaf nodes of the performance indicator tree are configured. As discussed previously, each node of the performance indicator tree may represent a single performance indicator. A node may have multiple dimensions and key figures (e.g., planned value, actual value, completion rate, etc.) associated with the performance indicator. Leaf nodes are at the lowest levels of the performance indicator tree and are not based on any other performance indicators. They are derived directly from raw transactional data 204. For example, the key figure of the leaf node “Fixed Assets” is calculated by aggregating balances of all fixed asset accounts, which may be retrieved from the database 129.

Each leaf node may be configured by defining its properties, such as name, one or more dimensions and one or more key figures. Dimensions generally refer to categories, while key figures generally refer to data items with numeric values that can be calculated. An exemplary leaf node may include the following properties:

Node name: Inventory;

Node dimensions: Company Code, Plant, Product Group, Product; and

Node key figures: Value with currency, Quantity with unit of measure.

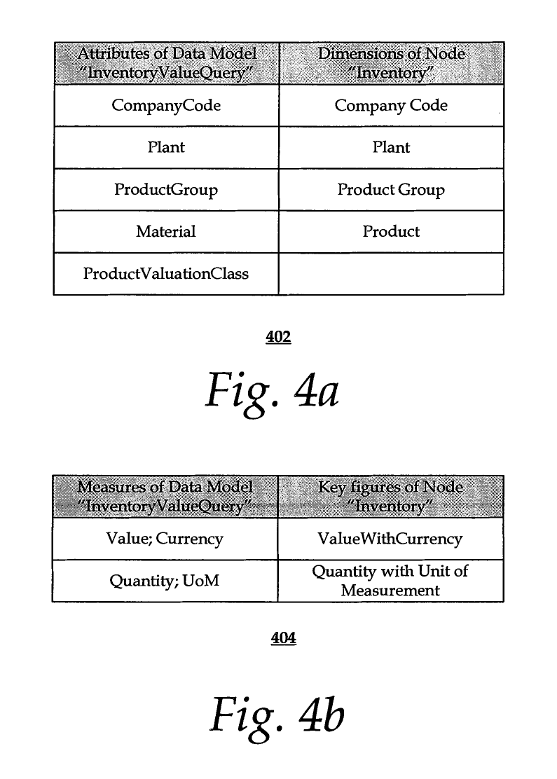

The leaf node may be further configured by mapping it to a data model 208. As discussed previously, the data model 208 may be selected from a set of pre-defined data models managed by the DBMS 122, and used to retrieve transactional data from the database 129. The attributes and measures of the selected data model 208 may be mapped to the dimensions and key figures of the leaf node. FIG. 4a shows an exemplary mapping table 402 that stores the associations between data model attributes and node dimensions, and FIG. 4b shows another exemplary mapping table 404 that stores the associations between data model measures and node key figures.

Referring to FIG. 4a, the calculation view “InventoryValueQuery” is selected from the set of existing pre-defined data models for linking to the leaf node “Inventory”. The calculation view may be selected by, for instance, the user via a user interface that presents a list of available pre-defined data models or calculation views. The data model “InventoryValueQuery” includes attributes: CompanyCode, Plant, ProductGroup, Material and ProductValuationClass. The exemplary mapping table 402 shows the mapping between these attributes and the respective dimensions of the leaf node “Inventory.” It should be noted that not every data model attribute (e.g. ProductValuationClass) may be mapped to a corresponding node dimension. The user may customize the mapping by selecting, via the user interface 152, the data model attributes to map to the corresponding dimensions of the leaf node.

Referring to FIG. 4b, the data model “InventoryValueQuery” may further include the measures: Value; currency and Quantity; UoM. These measures may be mapped to the key figures of the leaf node “Inventory,” as shown in mapping table 404. In some instances, there may be one or more data model measures that are not mapped to corresponding node key measures. The user may also customize the mapping by selecting, via the user interface 152, the data model measures to map to the corresponding key figures of the leaf node.

In some instances, filters may be defined for the attributes of the data model 208. For instance, referring back to FIG. 4a, there may be some goods (e.g., unfinished goods) that should not be included when computing the measures. Even though such goods may not exist physically, information of such goods may still be maintained for purposes of costing, designing, and so forth. The attribute “ProductValuationClass” of the corresponding data lines in the data model 208 may be marked as “PhAsm” (Phantom Assembly) to filter them out. The filter may be set as follows:
ProductValuationClass < > “PhAsm”
   By setting the filter, the performance indicator analytical framework 120 notifies the DBMS 122 that the data with such a value should not be retrieved.

Referring back to FIG. 3, at 304, the internal nodes of the performance indicator tree are configured. Internal nodes represent performance indicators that are derived from other performance indicators, instead of directly from transactional data. Key figure values of internal nodes may be calculated by applying a specified formula on the key figures of child nodes. Child nodes are lower level nodes that may be leaf nodes or other internal nodes.

Each internal node may be configured by defining its properties, such as name, one or more dimensions, one or more key figures and one or more child nodes. For instance, an internal node may have the following properties:

Node name: Current Assets;

Node dimensions: Company Code, Asset Type;

Node key figures: Value with currency; and

Child nodes: Inventory, Account Receivable.

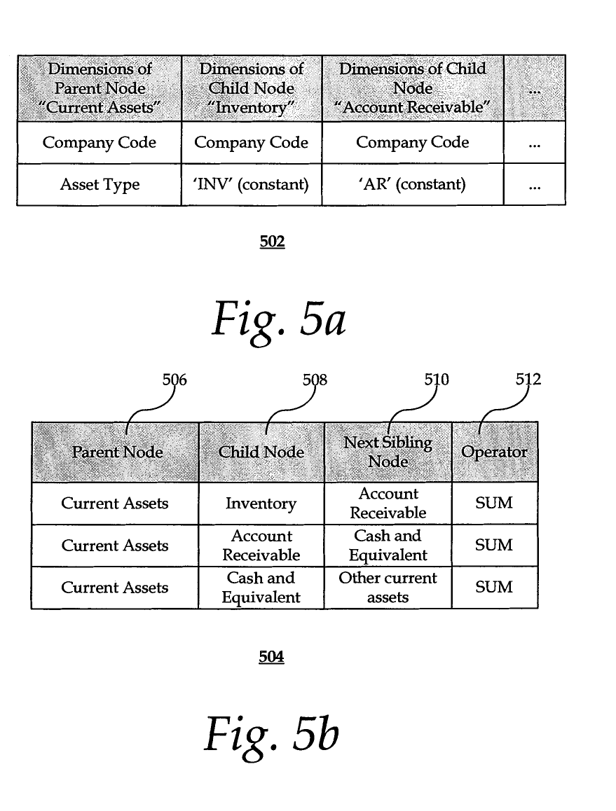

The internal node may be further configured by mapping it to one or more child nodes. The dimensions of the parent internal node may be mapped to the dimensions of the child nodes. FIG. 5a shows an exemplary mapping table 502 that stores the associations between parent node dimensions and the child node dimensions. The user may customize the mapping by selecting, via the user interface 152, the dimensions of the parent node to map to the corresponding dimensions of the child nodes. It should be appreciated that some dimensions of the parent node may not have corresponding dimensions in the child node. For instance, the parent node dimension “Asset Type” does not have a corresponding dimension in the child nodes “Inventory” and “Account Receivable.” A constant value (e.g., ‘INV’, ‘AR’) may be used to mark the non-existing dimension in the respective child nodes. By using a constant value, the source information of child nodes may be propagated to parent nodes.

FIG. 5b shows an exemplary mapping table 504 that stores the associations between parent nodes and child nodes. More particularly, the first column 506 stores the names of the parent node, the second column 508 stores the names of the corresponding child node, and the third column 510 stores the names of the corresponding next sibling node. The fourth column 512 stores the operator to be applied to the values of the key figures of the child node and next sibling node. It should be noted that other types of mapping tables are also useful. For instance, the mapping table may associate the key figures of the parent node to the key figures of the respective child nodes.

The internal node may be configured by defining the expression for computing its key figure value based on the key figure values of the child nodes. In some implementations, the expression is defined by specifying the operator between each pair of child node and next sibling node. The user may customize the expression by selecting, via the user interface 152, the operators to be applied. During runtime, the key figure value of the parent node may be calculated by applying the operator to the key figure values of each pair of child node and next sibling node. For example, as shown in FIG. 5b, the operator SUM is specified for each pair of child and next sibling nodes. Accordingly, the key figure value of the parent node “Current Assets” may be evaluated by adding up the key figure values of all the children nodes.

It should be appreciated that different operators may be specified for the pairs of child and next sibling nodes. The order in which the operators are applied may follow the standard order of operations: (1) exponents and roots; (2) multiplication and division; then (3) addition and subtraction. Parentheses or brackets may be used to denote precedence by grouping parts of an expression that should be evaluated first. Alternatively, an intermediate node may be defined to contain a partial result of applying the operators to the preceding pair of child and next sibling nodes.

Referring back to FIG. 3, at 306, the performance indicator tree may be further customized by assigning one or more view types to a node dimension. A view type is a graphical representation of data that may be presented in a report. The view type may be in the form of a table or a chart. Exemplary chart types include a geographic area map, a column or bar chart, a frequency chart, a histogram, a line or curve chart, a pie chart, a scatterplot chart, a geographical map, or a combination thereof.

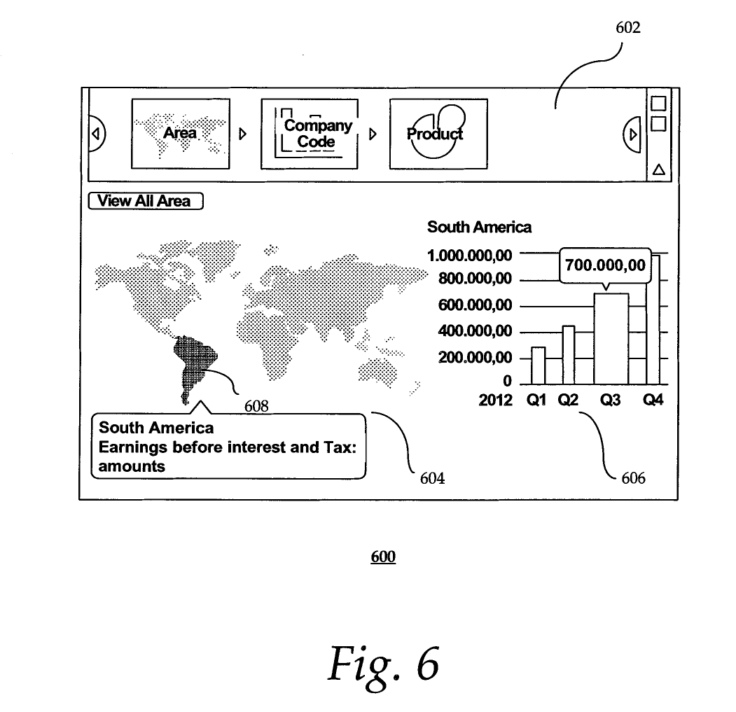

FIG. 6 shows an exemplary report 600 for the node “Revenue”. A scrollable menu 602 displays different dimensions associated with the node “Revenue”. Each dimension may be linked to an input parameter of a chart type. For example, the “Area” dimension is linked to the “Area” input parameter of the chart type “Geographic Map”. Accordingly, a geographic map 604 may be displayed in the report 600. By selecting the dimension “Area” displayed in the scrollable menu 602, the user may view the key figures of the “Revenue” node in the selected area 608 of the geographic map 604. In addition, the key figures may be further linked to a chart type “Bar Chart” 606. Similarly, the “Company Code” dimension may be linked to an input parameter of a “Bar Chart” chart type (not shown), while the “Product” dimension may be linked to an input parameter of a “Pie Chart” chart type (not shown). This allows the user to easily navigate and perform multi-dimensional analysis using a graphical chart view.

Referring back to FIG. 3, at 308, the configuration manager 210 may store the configuration data 202 associated with the performance indicator tree in the database 129 for subsequent retrieval. Such configuration data may be retrieved during runtime to generate performance indicator reports based on custom settings stored in the configuration data.

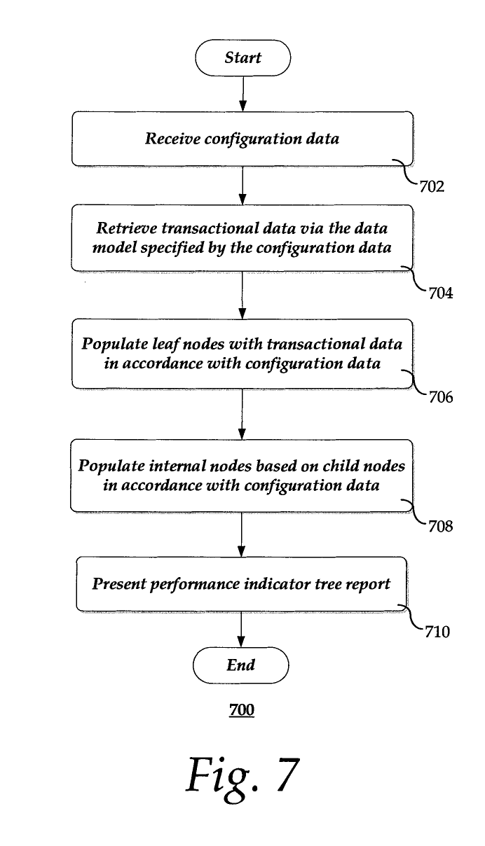

FIG. 7 shows a method 700 of generating a performance indicator report during runtime based on the configuration data. The method 700 may be implemented by the system 100 as previously described with reference to FIG. 1, or architecture 200 as previously described with reference to FIG. 2. It should be noted that in the following discussion, reference will be made, using like numerals, to the features described in FIGS. 1 and 2.

At 702, the configuration manager 210 retrieves the configuration data 202 from the database 129 via the data model 206. The configuration data 202 may have been generated by, for example, method 300 as previously described with reference to FIG. 3. As discussed previously, the configuration data 202 may include various settings of the leaf and internal nodes of the performance indicator tree.

At 704, the transactional data retriever 212 may dynamically retrieve transactional data 204 from the database 129 via the data model 208 specified by the configuration data 202. The data retrieval may further be controlled by customized filters specified in the configuration data 202.

At 706, the performance indicator controller 216 may populate the leaf nodes of the performance indicator tree with the transactional data 204. As described previously, transactional data 204 may be multi-dimensional. Configuration data 202 may include pre-defined mappings between dimensions of the leaf nodes and attributes of the transactional data 204. The values of the dimensions and key figures of the leaf nodes are derived directly from the values of the corresponding attributes and measures of the transactional data 204, in accordance with the pre-defined mappings.

At 708, the performance indicator controller 216 may populate the internal nodes of the performance indicator tree with the values of key figures computed by the formula calculator 214. The formula calculator 214 may compute the values of the key figures of the internal nodes based on the key figure values of the corresponding child nodes. The configuration data 202 may include pre-defined mappings between dimensions of the internal nodes and dimensions of the corresponding child nodes. The dimension values of the internal nodes are derived from the dimension values of the corresponding child nodes, in accordance with the pre-defined mappings. In addition, the value of the key figure of the internal node may be calculated by applying the pre-defined operators to the key figure values of the child nodes, in accordance with the pre-defined mappings and operators specified in the configuration data 202.

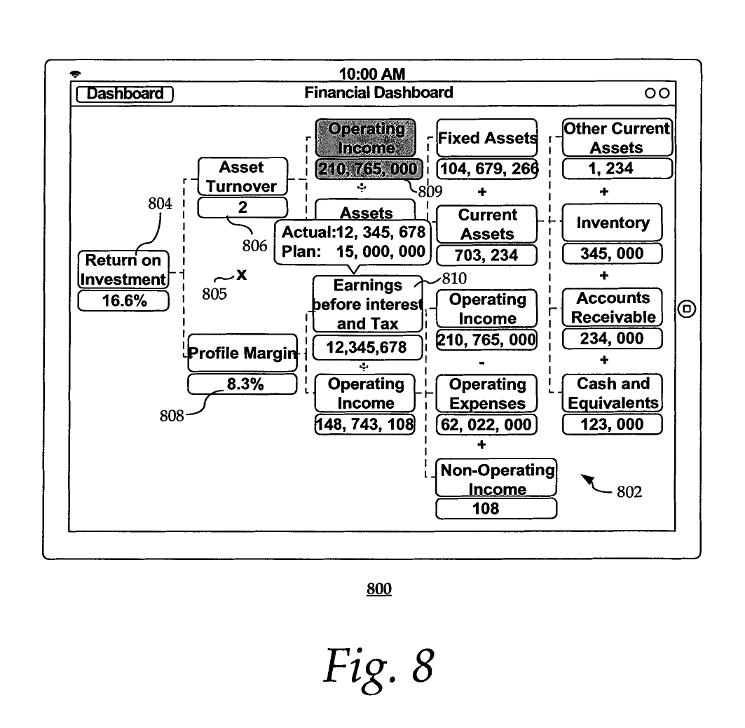

At 710, a report of the populated performance indicator tree is displayed. The report may be rendered by, for example, the UI renderer 152 and displayed at the user device 150. FIG. 8 shows an exemplary report 800. The report displays a performance indicator tree 802 with values derived based on the DuPont method. It should be appreciated that other types of methods may also be used.

The nodes, associated values, links to the child nodes, and operators are displayed. As shown, the highest-level parent node 804 for “Return on Investment” is displayed with the corresponding key figure value. The operator 805 that has been applied to the key figure values of the child nodes (806 and 808) to compute the key figure value of the parent node 804 is also displayed. This allows the user to easily understand the relationship between the different performance indicators. Node 809 with abnormal key figure values may be highlighted in, for example, a different color or shading. To determine if the key figure value is abnormal, it may be compared to one or more pre-determined threshold values. For instance, a key figure that falls outside a range defined by a pair of minimum and maximum threshold values (e.g., <low, high>) may be determined as abnormal. The minimum threshold value may be set to negative infinity, while the maximum threshold value may be set to positive infinity. Other threshold values may also be applied. The pre-determined threshold values may be customized by the user during configuration and stored as configuration data.

The user may navigate the performance indicator tree 802 by selecting the node of interest. For example, by selecting the node 810 representing the performance indicator “Earnings before Interest and Tax” (EBIT), the dimensions and key figure values (e.g., actual value, plan value) associated with the node 810 may be displayed. A more detailed view of the performance indicator represented by node 810 may also be presented in response to the user's selection.

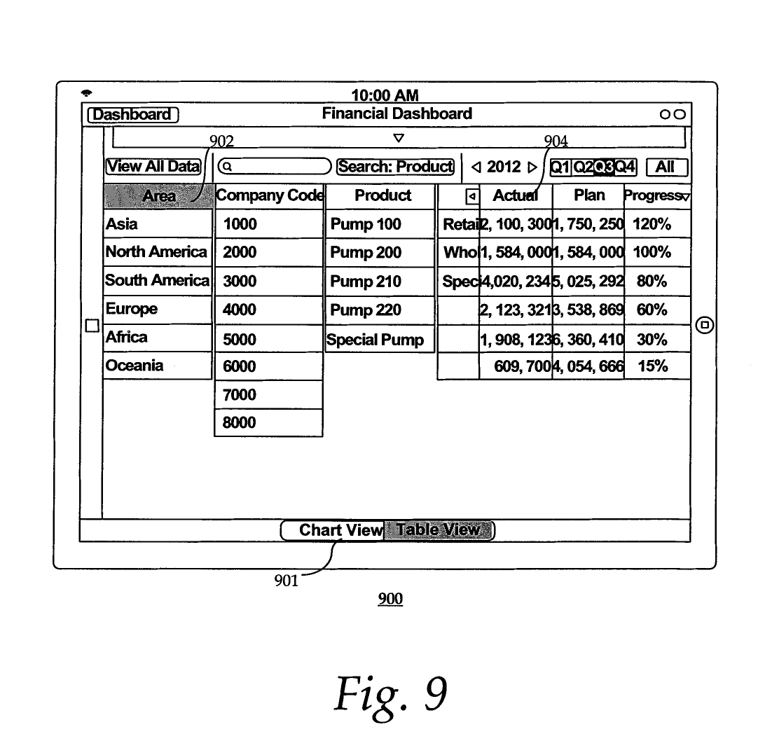

FIG. 9 shows a more detailed view 900 of the selected node 810 EBIT. More particularly, a table view of the node 810 is shown. The user may navigate the view 900 by selecting the dimension of interest 902 (e.g., Area). The key figure values 904 (e.g., Actual, Plan and Progress values) of EBIT specific to the selected dimension may then be displayed. Multiple dimensions may also be selected and combined for viewing. For example, the user may view the EBIT of product Pump 100 in area Asia.

The user may also switch to the chart view by selecting the respective user interface element 901. As discussed previously, FIG. 6 shows an exemplary chart type report 600. By selecting a specific area 608, the corresponding part of the map may be highlighted and the associated key figure values shown.

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

1. A computer-implemented method of generating a report, comprising:
receiving configuration data of a hierarchical structure, wherein a node of the hierarchical structure represents a performance indicator;
retrieving transactional data via a data model specified by the configuration data;
populating, in accordance with the configuration data, one or more lowest level nodes of the hierarchical structure based on the transactional data;
populating, in accordance with the configuration data, one or more internal nodes of the hierarchical structure based on one or more corresponding child nodes; and
presenting the report of the populated hierarchical structure.

2. A computer-implemented method of modeling performance indicators, comprising:
(i) configuring one or more lowest level nodes of a hierarchical structure with a node representing a performance indicator, including mapping the one or more lowest level nodes to one or more data models for retrieving transactional data;
(ii) configuring one or more internal nodes of the hierarchical structure, including mapping the one or more internal nodes to one or more corresponding child nodes; and
(iii) storing, in a database, configuration data generated in response to the steps (i) and (ii).

3. The computer-implemented method of claim 2 wherein configuring the one or more lowest level nodes comprises defining at least one name, at least one dimension and at least one key figure.

4. The computer-implemented method of claim 2 further comprising selecting the one or more data models from a set of pre-defined data models.

5. The computer-implemented method of claim 2 wherein mapping the one or more lowest level nodes to the one or more data models comprises mapping dimensions and key figures of the one or more lowest level nodes to attributes and measures of the one or more data models.

6. The computer-implemented method of claim 2 wherein configuring the one or more lowest level nodes comprises defining filters for one or more attributes of the one or more data models.

7. The computer-implemented method of claim 2 wherein configuring the one or more internal nodes comprises defining at least one name, at least one dimension, at least one key figure and at least one child node.

8. The computer-implemented method of claim 2 wherein mapping the one or more internal nodes to the one or more corresponding child nodes comprises mapping dimensions and key figures of the one or more internal nodes to dimensions and key figures of the one or more corresponding child nodes.

9. The computer-implemented method of claim 8 wherein mapping the key figures of the one or more internal nodes to the key figures of the one or more corresponding child nodes comprises defining one or more operators to be applied to values of the key figures of the one or more corresponding child nodes to compute values of the key figures of the one or more internal nodes.

10. The computer-implemented method of claim 2 further comprising assigning an input parameter of a view type to a dimension of the lowest level node or the internal node.

11. The computer-implemented method of claim 10 wherein the view type comprises a geographic map, a column or bar chart, a frequency chart, a histogram, a line or curve chart, a pie chart, a scatterplot chart, a geographical map, or a combination thereof.

12. The computer-implemented method of claim 2 wherein the database comprises an in-memory database.

13. The computer-implemented method of claim 2 further comprising generating a report based on the configuration data.

14. The computer-implemented method of claim 13 wherein generating the report based on the configuration data comprises:
retrieving transactional data via the one or more data models;
populating the one or more lowest level nodes of the hierarchical structure with the transactional data;
populating the one or more internal nodes of the hierarchical structure based on the one or more corresponding child nodes; and
presenting the report of the populated hierarchical structure.

15. The computer-implemented method of claim 14 wherein populating the one or more internal nodes of the hierarchical structure comprises calculating values of key figures of the internal nodes based on values of key figures of the one or more corresponding child nodes.

16. The computer-implemented method of claim 15 wherein calculating the values of the key figures of the internal nodes comprises applying operators to the values of key figures of the one or more corresponding child nodes, wherein the operators are pre-defined by the configuration data.

17. The computer-implemented method of claim 14 wherein populating the one or more internal nodes of the hierarchical structure comprises deriving values of dimensions of the internal nodes from values of dimensions of the one or more corresponding child nodes.

18. The computer-implemented method of claim 14 wherein presenting the report of the populated hierarchical structure comprises highlighting a node with an abnormal key figure value.

19. A non-transitory computer-readable medium having stored thereon program code, the program code executable by a computer to perform a method of modeling performance indicators, the method comprising:
(i) configuring a hierarchical structure with a node representing a performance indicator, including mapping one or more lowest level nodes to one or more data models for retrieving transactional data;
(ii) configuring one or more internal nodes of the hierarchical structure, including mapping the one or more internal nodes to one or more corresponding child nodes; and
(iii) storing, in a database, configuration data generated in response to the steps (i) and (ii).

20. A system comprising:
a non-transitory memory device for storing computer-readable program code; and
a processor in communication with the memory device, the processor being operative with the computer-readable program code to perform a method of modeling performance indicators, the method comprising:
(i) configuring a hierarchical structure with a node representing a performance indicator, including mapping one or more lowest level nodes to one or more data models for retrieving transactional data;
(ii) configuring one or more internal nodes of the hierarchical structure, including mapping the one or more internal nodes to one or more corresponding child nodes; and
(iii) storing, in a database, configuration data generated in response to the steps (i) and (ii).
